(19) United States
(12) Patent Application Publication
(10) Pub. No.: US 2008/0280805 A1
(43) Pub. Date: Nov. 13, 2008

(54) Process for manufacturing liquid detergent containing methyl ester sulfonate

(76) Inventors: Jack Wesley English, III, West Chester, OH (US); Eva Schneiderman, Mason, OH (US); Shari Joy Soper, Mason, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/818,103

(22) Filed: Jun. 13, 2007

Related U.S. Application Data
(60) Provisional application No. 60/814,728, filed on Jun. 19, 2006.

(51) Int. Cl. C11D 17/08

(52) U.S. Cl. 510/414

(57) ABSTRACT

Process for manufacturing stable liquid laundry detergent compositions containing sulfonated fatty acid alkyl ester surfactants and compositions resulting therefrom.

### CROSS REFERENCE TO RELATED APPLICATION

This application claims the benefit of U.S. Provisional Application Ser. No. 60/814,728, filed Jun. 19, 2006.

### FIELD OF INVENTION

This invention relates to a process for manufacturing liquid detergent compositions containing methyl ester sulfonate and products produced by said process.

### BACKGROUND OF THE INVENTION

Various ways to make stable liquid detergents via continuous processes, batch-making processes, and/or combination of thereof are known in the art. Similarly, it is known that some ingredients may be sensitive to the order of addition, while others can be included into the formulation at any time during the process. For example, caution needs to be taken during addition of enzymes, as these ingredients are sensitive to pH and temperature and can denaturate if added at certain points in the process.

Historically, it has generally been assumed that surfactants are insensitive to order of addition and can be added at any point during a liquid detergent manufacturing process. For instance, adding surfactants at the beginning of a manufacturing process can be viewed as beneficial since surfactants commonly serve in liquid detergent formulations as the main “building blocks” of liquid detergent formulations and often have significant impact on clarity and internal formula structure (e.g, micelar, hexagonal, cubic, etc.). Additionally, surfactants can also be added at the end of a manufacturing process to serve as a final control mechanism to achieve the desired physical properties of the liquid detergent.

Incorporation of methyl ester sulfonate (“MES”) surfactants into liquid laundry detergents is generally known. Similarly, MES is known to have good solubility in water and in liquid laundry detergent matrices. MES reportedly may exhibit significant pH drift in liquid laundry detergents. Methods of incorporating urea or similar compounds into MES-containing detergent formulations to reduce or eliminate pH drift have been taught. However, it has recently been surprisingly discovered that adding MES surfactants in the same way surfactants are traditionally added (i.e. at any point during a liquid laundry manufacturing process) may have undesirable and unexpected effects on the stability of the MES itself and on the liquid laundry detergent formulation.

It is therefore desirable to develop a process for manufacturing liquid detergents containing MES with improved stability and reduced pH drift.

### SUMMARY OF THE INVENTION

It has now surprisingly been found that even though MES can be used as a primary surfactant in liquid detergent compositions, addition of MES into the composition at the wrong time in the manufacturing process can lead to unstable, hazy, and cloudy composition Without being bound by any particular theory, it is believed that bulk formulation pH and temperature, as well as local pH and temperature changes during the liquid detergent manufacturing process significantly impact MES stability. The processes set forth herein exhibit advantages to which the present inventors are heretofore unaware.

Additionally, without being limited by theory, it is believed that traditional process steps for manufacturing liquid detergents may be used with the caveat being the methodology of MES addition must be such that the pH and temperature are maintained within set ranges throughout the process.

The present invention therefore relates to a process for manufacturing a liquid detergent composition comprising methyl ester sulfonate, wherein said process comprises at least one feed composition that is mixed with a bulk composition to create a resulting mixture, wherein said process operates within the following parameters:
a) the pH of a methyl ester sulfonate feed composition is from about 5 to about 9 and the temperature is from about 20° C. to about 100° C.;
b) the methyl ester sulfonates feed composition is added to a bulk composition, with mixing;
c) the pH of the bulk composition, just before the methyl ester sulfonate feed composition is added to the bulk composition, is from about 5 to about 9 and the temperature is from about 20° C. to about 100° C.;
d) the pH of the resulting mixture is from about 5 to about 9 and the temperature of the resulting mixture is maintained between from about 20° C. to about 100° C.

The present invention further relates to the process above wherein the methyl ester sulfonate has an average carbon length of 16.

The present invention further relates to the process above wherein the pH of the methyl ester sulfonate feed composition is from about 6 to about 8.

The present invention further relates to the process above wherein the pH of the methyl ester sulfonates feed composition is from about 6.5 to about 7.5.

The present invention further relates to the process above wherein the pH of the bulk composition is from about 6 to about 8.

The present invention further relates to the process above wherein the pH of the bulk composition is from about 6.5 to about 7.5.

The present invention further relates to the process above wherein the pH of the resulting mixture is from about 6 to about 8.

The present invention further relates to the process above wherein the pH of the resulting mixture is from about 6.5 to about 7.5.

The present invention further relates to the process above wherein the methyl ester sulfonates feed composition temperature is from about 20° C. to about 60° C.

The present invention further relates to the process above wherein the temperature of the bulk composition is from about 20° C. to about 50° C. when the methyl ester sulfonate is added

The present invention further relates to the process above wherein the liquid detergent composition comprises from about 0.5% to about 15%, by weight of the composition, of the methyl ester sulfonate.

The present invention further relates to the process above wherein the liquid detergent composition comprises from about 1% to about 5%, by weight of the composition, of methyl ester sulfonates, wherein said methyl ester sulfonates has an average chainlength of about 16.

The present invention further relates to the process above wherein any material or combination of materials, added to the resulting mixture after adding the methyl ester sulfonate feed composition, has a pH of from about 7.5 to about 9.

The present invention further relates to the process above wherein the bulk composition comprises detergent ingredients that are added before adding the methyl ester sulfonates feed.

The present invention further relates to the process above wherein the detergent ingredients are selected from neutralized anionic surfactants, neutralizing agents, solvents, hydrotropes, nonionic surfactants, acidifying agents, chelants, enzyme stabilizers, viscosity modifiers, and mixtures thereof.

The present invention further relates to the process above wherein the methyl ester sulfonates feed composition is added to the bulk composition as the last step in manufacturing the liquid detergent composition.

The present invention further relates to the process above wherein the liquid detergent comprises optional ingredients selected from enzymes, brighteners, minor ingredients, perfumes, colorants, polymers, dyes and combinations thereof.

The present invention further relates to a process for manufacture of a liquid laundry detergent composition comprising methyl ester sulfonate, wherein said process comprises the steps of:
a) forming a liquid laundry detergent partial composition in a first vessel, wherein said partial composition has a pH of from about 5 to about 9 and a temperature from about 20° C. to about 100° C.;
a) adjusting pH of the partial composition to from about 6 to about 9 to form an adjusted partial composition; and
b) adding to the adjusted partial composition from about 0.5% to about 15% of the methyl ester sulfonate, with mixing, to form said liquid laundry detergent composition.

The present invention further relates to a process for manufacture of a liquid laundry detergent composition comprising from about 1% to about 5%, by weight of the composition, of a combination of methyl ester sulfonate having an average chainlength of about 16, wherein said process comprises the sequential steps of:
a) forming a liquid laundry detergent partial composition in a first vessel, wherein said partial composition has a pH of from about 5 to about 9 and a temperature from about 20° C. to about 100° C. and comprises detergent ingredients, wherein said detergent ingredients comprise;
   i) neutralized anionic surfactants that are added to the first vessel in a first sub-step;
   ii) neutralizing agents, solvents, hydrotropes and/or nonionic surfactants that are added to the first vessel in a second sub-step; iii) acidifying agents that are added to the first vessel in a third sub-step;
   iv) chelants, enzyme stabilizers and/or viscosity modifiers that are added to the first vessel in a fourth sub-step;
b) heating the liquid laundry detergent partial composition in the first vessel to a temperature of from about 20° C. to about 60° C.;
c) adding to the partial composition from about 0.5% to about 15% methyl ester sulfonate with mixing to form said liquid laundry detergent composition comprising methyl ester sulfonate; and
d) adding to the partial composition minor optional ingredients having an individual or grouped pH of from about 5 to about 9 and selected from enzymes, brighteners, minor ingredients, perfumes, colorants, polymers, dyes and combinations thereof.

The present invention further relates to a liquid laundry detergent composition comprising methyl ester sulfonate, produced by any one of the processes set forth above.

The present invention further relates to a method of preventing or reducing disalt formation in a liquid laundry detergent composition comprising methyl ester sulfonate, said method comprising maintaining the pH of the manufacturing process between about 5 and about 9 and maintaining the temperature of the manufacturing process between about 20° C. to about 100° C.

### DETAILED DESCRIPTION OF THE INVENTION

The liquid detergent compositions manufactured by the processes set forth herein contain alkyl ester sulfonates. Such compositions may contain a relatively large amount of an aqueous liquid carrier. The processes set forth herein as well as these compositions and optional ingredients for such compositions are described in detail as follows.

All measurements referenced herein are at room temperature (about 21.1° C.) and at atmospheric pressure, unless otherwise indicated.

The processes and compositions of the present invention can include, consist essentially of, or consist of, the components and/or steps of the present invention as well as other ingredients described herein. As used herein, “consisting essentially of” means that the composition, process, or component may include additional ingredients or steps, but only if the additional ingredients do not materially alter the basic and novel characteristics of the claimed compositions or processes.

All percentages, parts and ratios are based upon the total weight of the liquid detergent compositions of the present invention, unless otherwise specified. All such weights as they pertain to listed ingredients are based on the active level and, therefore do not include carriers or by-products that may be included in commercially available materials, unless otherwise specified.

All documents cited are, in relevant part, incorporated herein by reference; the citation of any document is not to be construed as an admission that it is prior art with respect to the present invention.

The process of manufacturing a liquid detergent composition comprising methyl ester sulfonate includes at least one feed composition that combines with a bulk composition, to create a resulting mixture. A methyl ester sulfonate feed composition is added to and mixed with a bulk composition, whereby a resulting mixture is formed. The resulting mixture may be the liquid detergent composition, or other ingredients may need to be added before the resulting mixture becomes the liquid detergent composition.

The process of manufacturing a liquid detergent composition comprising methyl ester sulfonate (“MES”) can include the sequential steps of: forming a liquid detergent partial composition in a first vessel, wherein said partial composition has a pH of from about 5 to about 9; adjusting pH of the partial composition to from about 6 to about 9 to form an adjusted partial composition; and adding to the adjusted partial composition from about 0.5% to about 15% MES with mixing to form said liquid detergent composition comprising MES.

The compositions comprise MES surfactant and may contain one or more optional ingredients.

These components are outlined in more detail below.

### Liquid Detergent Composition

The laundry detergent compositions formed by the processes of the present invention are generally in liquid form, including a gel form. In one embodiment, the compositions are heavy duty liquid laundry compositions.

### Surfactant

The liquid detergent compositions formed by the processes of the present invention comprise a surfactant in an amount sufficient to provide desired cleaning properties. This surfactant includes MES and may optionally contain mixtures of MES with other surfactants.

In one embodiment, the liquid detergent composition comprises, by weight, from about 5% to about 90% of surfactant, and more specifically from about 5% to about 70% of surfactant, and even more specifically from about 5% to about 40%, by weight of the composition, of surfactant. In addition to the MES surfactant, other surfactants that may be used herein include anionic, nonionic, cationic, zwitterionic and/or amphoteric surfactants.

In one embodiment, the liquid detergent composition comprises from about 0.5% to about 15%, by weight of the composition, of MES, alternatively from about 1% to about 5%.

### Alkyl Ester Sulfonate Surfactant (“MES”)

As used herein, “MES” refers to alkyl ester sulfonate surfactants, commonly used in methyl ester sulfonate form. The present invention relates to processes for the manufacture of liquid detergent compositions comprising a sulfonated fatty acid alkyl ester surfactant (“alkyl ester surfactant”). MES surfactants useful herein include sulfonated fatty acid alkyl esters of the formula:

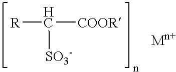

wherein R is, on the average, a C6 to C22 alkyl, R′ is on the average a C1 to C8 alkyl, M is an alkali metal or alkaline earth metal cation, or a mixture thereof, and n is 1 when M is an alkali metal cation and n is 2 when M is an alkaline earth metal cation.

The hydrophobic portion of these sulfonated alkyl esters have the sulfonate group at the α-position, i.e., the sulfonate group is positioned at the carbon atom adjacent the carbonyl group. The alkyl portion of the hydrophobic portion, which corresponds to the R portion of the sulfonated fatty acid alkyl esters, is on the average a C6 to C22 alkyl. Preferably, the alkyl portion of this hydrophobic portion, R, is on the average a straight-chain C8 to C16 hydrocarbon particularly when R′ is methyl.

R′, forming the ester portion of the sulfonated alkyl esters, is on the average a C1 to C8 alkyl. Preferably, R′ is on the average a C1 to C6 alkyl, and most preferably a C1 alkyl, i.e., methyl.

In one embodiment, the distribution is such that R is, on the average, a C14 to C16 alkyl (approximately, for example, a 95% C14, 5% C16 mixture) and R′ is methyl. In another embodiment, the distribution is such that R is, on the average, a C12 to C16 alkyl (approximately, for example, a 3% C12, 28% C14, 69% C16 mixture) and R′ is methyl. In yet another embodiment, the distribution is such that R is, on the average, a C10 to C16 alkyl (approximately, for example, a 60% C10, 35% C12, 5% C14 mixture) and R′ is methyl. In yet a further embodiment, blends of the aforementioned distributions of R and R′ may also be employed.

The cationic portion, M, is an alkali metal or alkaline earth metal cation or mixture thereof. Preferably, M is chosen from sodium, potassium, lithium, magnesium, calcium, and mixtures thereof. Most preferably, M is sodium or a mixture containing sodium. When M is an alkali metal cation (valence=1) n is 1 and when M is an alkaline earth metal cation (valence=2) n is 2.

In one embodiment, the methyl ester sulfonate has an average carbon length of about 16.

Methods of making alkyl ester surfactants have been well described and are known to those skilled in art the art. See U.S. Pat. Nos. 4,671,900; 4,816,188; 5,329,030; 5,382,677; 5,384,422; 5,475,134; 5,587,500; 6,780,830. MES is commercially available from Huish.

MES used in the processes and compositions of the present invention may be included in any form, as solid/flake material and/or liquid surfactant premix. Despite an excellent solubility of MES in water and liquid detergent matrices, it has also been surprisingly found that that incorporation of liquid detergent compositions is most advantageous in higher than room temperatures and allows for less mixing time. Further without being limited by theory, it has been surprisingly found that upon late addition of MES in liquid detergent compositions, it is possible to prevent significant pH drift (significant meaning higher than 0.1-0.4% units) after the addition of MES. It has been also found that MES does not always have to be added as very last ingredient to yield stable, clear and isotropic liquid detergent compositions. Ingredients such as polymers, water, perfumes, dyes, brightener, mixtures thereof, and the like, could be also added as long as bulk and local pH does not dramatically change.

Anionic Surfactants

Suitable anionic surfactants useful herein include any of the conventional anionic surfactant types typically used in liquid detergent products. These include the alkyl benzene sulfonic acids and their salts as well as alkoxylated or non-alkoxylated alkyl sulfate materials.

Exemplary anionic surfactants are the alkali metal salts of C₁₀₋₁₆ alkyl benzene sulfonic acids, preferably C₁₁₋₁₄ alkyl benzene sulfonic acids. In one embodiment, the alkyl group is linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Preferred are the sodium and potassium linear straight chain alkylbenzene sulfonates in which the average number of carbon atoms in the alkyl group is from about 11 to 14. Sodium C₁₁-C₁₄, e.g., C₁₂, LAS is a specific example of such surfactants.

Another exemplary, type of anionic surfactant comprises ethoxylated alkyl sulfate surfactants. Such materials, also known as alkyl ether sulfates or alkyl polyethoxylate sulfates, are those which correspond to the formula: R′—O—(C₂H₄O)ₙ—SO₃M wherein R′ is a C₈-C₂₀ alkyl group, n is from about 1 to 20, and M is a salt-forming cation. In a specific embodiment, R′ is C₁₀-C₁₈ alkyl, n is from about 1 to 15, and M is sodium, potassium, ammonium, alkylammonium, or alkanolammonium. In more specific embodiments, R′ is a C₁₂-C₁₆, n is from about 1 to 6 and M is sodium.

The alkyl ether sulfates will generally be used in the form of mixtures comprising varying R′ chain lengths and varying degrees of ethoxylation. Frequently such mixtures will inevitably also contain some non-ethoxylated alkyl sulfate materials, i.e., surfactants of the above ethoxylated alkyl sulfate formula wherein n=0. Non-ethoxylated alkyl sulfates may also be added separately to the compositions of this invention and used as or in any anionic surfactant component which may be present. Specific examples of non-alkoyxylated, e.g., non-ethoxylated, alkyl ether sulfate surfactants are those produced by the sulfation of higher C₈-C₂₀ fatty alcohols. Conventional primary alkyl sulfate surfactants have the general formula: ROSO₃-M⁺ wherein R is typically a linear C₈-C₂₀ hydrocarbyl group, which may be straight chain or branched chain, and M is a water-solubilizing cation. In specific embodiments, R is a C₁₀-C₁₅ alkyl, and M is alkali metal, more specifically R is C₁₂-C₁₄ and M is sodium.

Examples of anionic surfactants useful herein include: a) C₁₁-C₁₈ alkyl benzene sulfonates (LAS); b) C₁₀-C₂₀ primary, branched-chain and random alkyl sulfates (AS); c) C₁₀-C₁₈ secondary (2,3) alkyl sulfates having formulae (I) and (II):

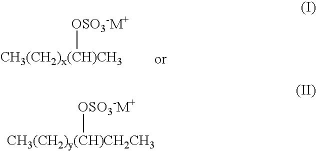

wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of preferred cations including sodium, potassium, ammonium, and mixtures thereof, and x is an integer of at least about 7, preferably at least about 9, and y is an integer of at least 8, preferably at least about 9; d) C₁₀-C₁₈ alkyl alkoxy sulfates (AEₓS) wherein preferably x is from 1-30; e) C₁₀-C₁₈ alkyl alkoxy carboxylates preferably comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

Nonionic Surfactants

Suitable nonionic surfactants useful herein can comprise any of the conventional nonionic surfactant types typically used in liquid detergent products. These include alkoxylated fatty alcohols and amine oxide surfactants. Typical for use in the liquid detergent compositions herein are those nonionic surfactants which are normally liquid.

Suitable nonionic surfactants for use herein include the alcohol alkoxylate nonionic surfactants. Alcohol alkoxylates are materials which correspond to the general formula: R¹(CₘH₂ₘO)ₙOH wherein R¹ is a C₈-C₁₆ alkyl group, m is from 2 to 4, and n ranges from about 2 to 12. Preferably R¹ is an alkyl group, which may be primary or secondary, that contains from about 9 to 15 carbon atoms, more preferably from about 10 to 14 carbon atoms. In one embodiment, the alkoxylated fatty alcohols will also be ethoxylated materials that contain from about 2 to 12 ethylene oxide moieties per molecule, more preferably from about 3 to 10 ethylene oxide moieties per molecule.

The alkoxylated fatty alcohol materials useful in the liquid detergent compositions herein will frequently have a hydrophilic-lipophilic balance (HLB) which ranges from about 3 to 17. The HLB of this material may range from about 6 to 15, alternatively from about 8 to 15. Alkoxylated fatty alcohol nonionic surfactants have been marketed under the tradenames NEODOL and DOBANOL by the Shell Chemical Company.

Another suitable type of nonionic surfactant useful herein is the amine oxide surfactants. Amine oxides are materials which are often referred to in the art as “semi-polar” nonionics. Amine oxides have the formula: R(EO)ₓ(PO)_{y}(BO)_{z}N(O)(CH₂R′)₂.qH₂O. In this formula, R is a relatively long-chain hydrocarbyl moiety which can be saturated or unsaturated, linear or branched, and can contain from 8 to 20, preferably from 10 to 16 carbon atoms, and is more preferably C₁₂-C₁₆ primary alkyl. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C₁₂₋₁₄ alkyldimethyl amine oxide.

Other nonionic surfactants include: a) C₁₂-C₁₈ alkyl ethoxylates, such as, NEODOL® nonionic surfactants from Shell; b) C₆-C₁₂ alkyl phenol alkoxylates wherein the alkoxylate units are a mixture of ethyleneoxy and propyleneoxy units; c) C₁₂-C₁₈ alcohol and C₆-C₁₂ alkyl phenol condensates with ethylene oxide/propylene oxide block polymers such as Pluronic® from BASF; d) C₁₄-C₂₂ mid-chain branched alcohols, BA, as discussed in U.S. Pat. No. 6,150,322; e) C₁₄-C₂₂ mid-chain branched alkyl alkoxylates, BAEₓ, wherein x 1-30, as discussed in U.S. Pat. No. 6,153,577, U.S. Pat. No. 6,020,303 and U.S. Pat. No. 6,093,856; f) Alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; g) Polyhydroxy fatty acid amides as discussed in U.S. Pat. No. 5,332,528, WO 92/06162, WO 93/19146, WO 93/19038, and WO 94/09099; and h) ether capped poly(oxyalkylated) alcohol surfactants as discussed in U.S. Pat. No. 6,482,994 and WO 01/42408.

Anionic/Nonionic Combinations

In the laundry detergent compositions herein, the surfactant component may include combinations of anionic and nonionic surfactants with MES. When this is the case, the weight ratio of anionic to nonionic will typically range from 10:90 to 90:10, more typically from 30:70 to 70:30.

Cationic Surfactants

Cationic surfactants are well known in the art and examples of these include quaternary ammonium surfactants, which can have up to 26 carbon atoms. Additional examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Zwitterionic Surfactants

Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C₈ to C₁₈ (preferably C₁₂ to C₁₈) amine oxides and sulfo and hydroxy betaines, such as N-alkyl-N,N-dimethylammino-1-propane sulfonate where the alkyl group can be C₈ to C₁₈, preferably C₁₀ to C₁₄.

Ampholytic Surfactants

Examples of ampholytic surfactants include: aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 to Laughlin et al., issued Dec. 30, 1975 at column 19, lines 18-35, for examples of ampholytic surfactants.

Parameters

The process for manufacturing a liquid detergent according to the present invention includes adding at least one feed composition to a bulk composition to create a resulting mixture, wherein the process operates within certain parameters.

As used herein “feed composition” refers to a smaller portion of the overall formulation that is added during processing.

As used herein “bulk composition” refers to the primary composition that is typically formed prior to introduction of one or more feed compositions. The combination of all feed compositions and additional ingredients with the bulk composition leads to the manufacture of the liquid detergent.

As used herein, “methyl ester sulfonate feed composition” refers to either pure MES or a combination of MES with other ingredients, that is to be added to the bulk composition.

As used herein, “resulting mixture” refers to the combination of the methyl ester sulfonate composition with the methyl ester sulfonate feed composition. In one embodiment, the liquid detergent comprises the resulting composition and nothing further.

The processes of the present invention operate within the following parameters:
a) the pH of the methyl ester sulfonate feed composition is from about 5 to about 9, alternatively from about 6 to about 8, alternatively from about 6.5 to about 7.5; and the temperature is from about 20° C. to about 100° C., alternatively from about 20° C. to about 60° C., alternatively from about 20° C. to about 50° C.;
b) the pH of the bulk composition, just before the methyl ester sulfonate composition is added is from about 5 to about 9, alternatively from about 6 to about 8, alternatively from about 6.5 to about 7.5; and the temperature is from about 20° C. to about 100° C., alternatively from about 20° C. to about 60° C., alternatively from about 20° C. to about 50° C.;
c) the pH of resulting mixture is from about 5 to about 9, alternatively from about 6 to about 8, alternatively from about 6.5 to about 7.5; and the temperature is from about 20° C. to about 100° C., alternatively from about 20° C. to about 60° C., alternatively from about 20° C. to about 50° C.

### Process for Manufacturing Detergent Compositions

In one embodiment, the processes for manufacture of a liquid detergent composition comprising MES herein includes the following sequential steps.

First Step

The first step of the processes of the present invention is to form a liquid detergent partial composition in a first vessel, wherein said partial composition has a pH of from about 5 to about 9, alternatively from about 6 to about 9. As used herein “partial composition” means at least one of the ingredients of the overall composition.

Second Step

Secondly, the pH the partial composition is adjusted so that it is in the range of from about 6 to about 9, preferably from 7 to 9, alternatively from about 7.5 to 8.5, alternatively from about 8 to about 8.5, thereby forming an adjusted partial composition. In one embodiment, the temperature of the adjusted partial composition is from about 20° C. to about 60° C. when the MES is added in the third step. In another embodiment, the temperature of the adjusted partial composition is from about 30° C. to about 55° C., alternatively from about 30° C. to about 50° C. when the MES is added in the third step

Third Step

Third, from about 0.5% to about 15% MES is added to the adjusted partial composition with mixing to form said liquid detergent composition comprising MES. Mixing can occur by any standard means.

### Detergent Ingredients

In one embodiment of the process herein, any material or combination of materials added to the liquid detergent composition after the step of adding MES has a pH of from about 7.5 to about 9, alternatively from about 8 to about 9.

In one embodiment of the process herein, the liquid detergent partial composition comprises detergent ingredients that are added to the first vessel before adding MES. In one embodiment of the process herein, the detergent ingredients are selected from neutralized anionic surfactants, neutralizing agents, solvents, hydrotropes, nonionic surfactants, acidifying agents, chelants, enzyme stabilizers, viscosity modifiers or mixtures thereof.

In one embodiment of the process herein, minor optional ingredients selected from enzymes, brighteners, minor ingredients, perfumes, colorants, polymers, dyes and combinations thereof are added to the liquid detergent composition.

### Product-by-Process

The present invention further relates to a liquid detergent composition comprising MES produced by any of the processes above.

### Other Optional Detergent Ingredients

The laundry detergent compositions herein may contain one or more optional detergent ingredients.

Optional detergent ingredients useful herein include those known in the art for use in laundry detergents such as hueing dyes, opacifiers, viscosity modifiers, detersive builders, enzymes, enzyme stabilizers (such as propylene glycol, boric acid and/or borax), suds suppressors, soil suspending agents, soil release agents, other fabric care benefit agents, polymers, softeners, pH adjusting agents, chelating agents, smectite clays, solvents, hydrotropes and phase stabilizers, structuring agents, dye transfer inhibiting agents, optical brighteners, perfumes and coloring agents. The various optional detergent composition ingredients, if present in the compositions herein, should be utilized at concentrations conventionally employed to bring about their desired contribution to the composition or the laundering operation. Frequently, the total amount of such optional detergent composition ingredients can range from about 0.1% to about 50%, more preferably from about 1% to about 30%, by weight of the composition.

In one embodiment of the instant invention, the adjunct ingredient may be selected from builders, brightener, dye transfer inhibitor, chelants, polyacrylate polymers, dispersing agents, colorant dye, hueing dyes, perfumes, processing aids, bleaching additives, bleach activators, bleach precursors, bleach catalysts, solvents, co-solvents, hydrotropes, liquid carrier, phase stabilizers, soil release polymers, enzyme stabilizers (other than the reversible peptide protease inhibitor, and/or the reversible aromatic protease inhibitor described herein), suds suppressors, opacifiers, suds boosters, anticorrosion agents, radical scavengers, chlorine scavengers, structurants, fabric softening additives, other fabric care benefit agents, pH adjusting agents, fluorescent whitening agents, smectite clays, structuring agents, preservatives, thickeners, coloring agents, fabric softening additives, rheology modifiers, fillers, germicides and mixtures thereof. (See, U.S. Pat. No. 3,936,537, issued Feb. 3, 1976 to Baskerville, Jr. et al., See also, U.S. Pat. No. 4,285,841, Barrat et al., issued Aug. 25, 1981, See also, U.S. Pat. No. 4,844,824 Mermelstein et al., issued Jul. 4, 1989, See also, U.S. Pat. No. 4,663,071, Bush et al., See also, U.S. Pat. No. 4,909,953, Sadlowski, et al. issued Mar. 20, 1990, See also, U.S. Pat. No. 3,933,672, issued Jan. 20, 1976 to Bartoletta et al. and U.S. Pat. No. 4,136,045, issued Jan. 23, 1979 to Gault et al. and See also, U.S. Pat. No. 4,762,645, Tucker et al, issued Aug. 9, 1988, Column 6, line 3 through Column 7, line 24.)

The list of optional detergent ingredients above is not intended to be exhaustive and other optional detergent ingredients which may not be listed, but are well known in the art, may also be included in the composition.

### Aesthetics

The detergent compositions set forth herein, as well as any commercial or non-commercial container therefore, may have any desired appearance or aesthetics. The composition and/or container may be opaque, transparent or translucent, of any color or appearance, such as a pearlescent liquid. In one embodiment, the concentrated detergent composition may contain air or gas bubbles, suspended liquid droplets, simple or multiple emulsion droplets, suspended particles and the like and combinations thereof. Additionally, the composition and/or container may be any color or combination of colors. Furthermore, the composition and/or container may have any additional visual treatments, such as for example, a combination of varied refractive indices, pearlescence, opalescence, reflective, holographic effect, metallic color, gloss finish, matte finish and the like and combinations thereof.

In one embodiment, the laundry detergent composition of the present invention is translucent or transparent and is packaged in a container that is translucent or transparent, alternatively, such composition further contains a UV absorber or optical brightener in combination with a hueing dye and MES surfactant.

### EXAMPLES

### Example I

### Process for Manufacturing Heavy Duty Liquid Laundry Detergent containing MES

Composition 1A is set forth in the following chart. This composition is prepared according to the order of addition, pH and heating requirements set forth in Table A. All ingredients with the exception of C16MES are added in the liquid form; either as molten ingredients, and/or in respective liquid premixes containing, water and appropriate solvents. MES is added as liquid in the presence of water and solvent, and/or as flake.

The resulting composition has good stability and has a pH drift of less than 0.5% pH unit.

### Example 1A

| Ingredient | % by weight of composition |
|---|---|
| Anionic surfactant | 20 |
| C16MES | 4.50 |
| Nonionic surfactant | 0.80 |
| Citric Acid | 4 |
| Fatty acid | 1.5 |
| Enzymes | 2.0 |
| Borax | 2.00 |
| Calcium formate | 0.1 |
| Viscosity modifiers | 3.0 |
| DTPA | 0.25 |
| Optical brightener | 0.2 |
| Ethanol | 2.5 |
| 1,2 propanediol | 4.0 |
| Diethylene glycol | 3.25 |
| PEG 4000 | 0.10 |
| MEA | 2.5 |
| Sodium hydroxide | 3.25 |
| Sodium formate | 0.15 |
| DC 1520 (suds suppressor) | 0.010 |
| Dyes and perfumes | 0.5 |
| Water | to 100% |

TABLE A

| | | Bulk pH of | |
|---|---|---|---|
| Step | Component | formula | temperature |
| 1 | Anionic Surfactant | 9-10 | |
| | Neutralized Paste | | |
| 2 | Neutralizing agents | 9-13 | |
| | (MEA + NaOH) | | |
| 3 | Solvents and hydrotropes | 9-13 | |
| 4 | Nonionic surfactant | 9-13 | |
| 5 | Brightener | 9-13 | |
| (Optional) | | | |
| 6 | Chelants | 9-13 | |
| 8 | Citric Acid | approx 7 with | Heat |
| | | localized | released |
| | | zones as low as 1 | |
| 9 | Cationic/zwitterionic | approx 7 | Heat |
| | surfactants | | released |
| 10 | Fatty acid | approx 6 with | Heat |
| | | localized | released |
| | | zones as low as 4 | |
| 11 | Borax and calcium formate | approx 7.5 | |
| 12 | pH trim (with NaOH and/or | to 8.0-8.5 | |
| | MEA) | | |
| 13 | MES flake or solution) | 8-8.5 | Warm batch |
| | Water/Ice | 8.0-8.5 | Cooling |
| (Optional) | Polymers | 8.0-8.5 | Temperature |
| | | | stabilized |
| (Optional) | Optional Brightener | 8.0-8.5 | |
| | 49 premix | | |
| (Optional) | Perfumes/colorants/dyes | 8.0-8.5 | |
| (Optional) | Enzymes | 8.0-8.5 | |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for manufacturing a liquid detergent composition comprising methyl ester sulfonate, wherein said process comprises at least one feed composition that is mixed with a bulk composition to create a resulting mixture, wherein said process operates within the following parameters:
a) the pH of a methyl ester sulfonate feed composition is from about 5 to about 9 and the temperature is from about 20° C. to about 100° C.;
b) the methyl ester sulfonates feed composition is added to a bulk composition, with mixing;
c) the pH of the bulk composition, just before the methyl ester sulfonate feed composition is added to the bulk composition, is from about 5 to about 9 and the temperature is from about 20° C. to about 100° C.;
d) the pH of the resulting mixture is from about 5 to about 9 and the temperature of the resulting mixture is maintained between from about 20° C. to about 100° C.

2. A process according to claim 1 wherein the methyl ester sulfonate has an average carbon length of 16.

3. A process according to claim 1 wherein the pH of the methyl ester sulfonate feed composition is from about 6 to about 8.

4. A process according to claim 1 wherein the pH of the methyl ester sulfonates feed composition is from about 6.5 to about 7.5.

5. A process according to claim 1 wherein the pH of the bulk composition is from about 6 to about 8.

6. A process according to claim 1 wherein the pH of the bulk composition is from about 6.5 to about 7.5.

7. A process according to claim 1 wherein the pH of the resulting mixture is from about 6 to about 8.

8. A process according to claim 1 wherein the pH of the resulting mixture is from about 6.5 to about 7.5.

9. A process according to claim 1 wherein the methyl ester sulfonates feed composition temperature is from about 20° C. to about 60° C.

10. A process according to claim 3 wherein the temperature of the bulk composition is from about 20° C. to about 50° C. when the methyl ester sulfonate is added

11. A process according to claim 1 wherein the liquid detergent composition comprises from about 0.5% to about 15%, by weight of the composition, of the methyl ester sulfonate.

12. A process according to claim 1 wherein the liquid detergent composition comprises from about 1% to about 5%, by weight of the composition, of methyl ester sulfonates, wherein said methyl ester sulfonates has an average chainlength of about 16.

13. A process according to claim 1, wherein any material or combination of materials, added to the resulting mixture after adding the methyl ester sulfonate feed composition, has a pH of from about 7.5 to about 9.

14. A process according to claim 1 wherein the bulk composition comprises detergent ingredients that are added before adding the methyl ester sulfonates feed.

15. A process according to claim 9 wherein the detergent ingredients are selected from neutralized anionic surfactants, neutralizing agents, solvents, hydrotropes, nonionic surfactants, acidifying agents, chelants, enzyme stabilizers, viscosity modifiers, and mixtures thereof.

16. A process according to claim 1 wherein the methyl ester sulfonates feed composition is added to the bulk composition as the last step in manufacturing the liquid detergent composition.

17. A process according to claim 1 wherein the liquid detergent comprises optional ingredients selected from enzymes, brighteners, minor ingredients, perfumes, colorants, polymers, dyes and combinations thereof.

18. A process for manufacture of a liquid laundry detergent composition comprising methyl ester sulfonate, wherein said process comprises the steps of:
a) forming a liquid laundry detergent partial composition in a first vessel, wherein said partial composition has a pH of from about 5 to about 9 and a temperature from about 20° C. to about 100° C.;
c) adjusting pH of the partial composition to from about 6 to about 9 to form an adjusted partial composition; and
d) adding to the adjusted partial composition from about 0.5% to about 15% of the methyl ester sulfonate, with mixing, to form said liquid laundry detergent composition.

19. A process for manufacture of a liquid laundry detergent composition comprising from about 1% to about 5%, by weight of the composition, of a combination of methyl ester sulfonate having an average chainlength of about 16, wherein said process comprises the sequential steps of:
a) forming a liquid laundry detergent partial composition in a first vessel, wherein said partial composition has a pH of from about 5 to about 9 and a temperature from about 20° C. to about 100° C. and comprises detergent ingredients, wherein said detergent ingredients comprise;
i) neutralized anionic surfactants that are added to the first vessel in a first sub-step;
ii) neutralizing agents, solvents, hydrotropes and/or nonionic surfactants that are added to the first vessel in a second sub-step;
iii) acidifying agents that are added to the first vessel in a third sub-step;
iv) chelants, enzyme stabilizers and/or viscosity modifiers that are added to the first vessel in a fourth sub-step;
b) heating the liquid laundry detergent partial composition in the first vessel to a temperature of from about 20° C. to about 60° C.;
c) adding to the partial composition from about 0.5% to about 12% methyl ester sulfonate with mixing to form said liquid laundry detergent composition comprising methyl ester sulfonate; and
d) adding to the partial composition minor optional ingredients having an individual or grouped pH of from about 5 to about 9 and selected from enzymes, brighteners, minor ingredients, perfumes, colorants, polymers, dyes and combinations thereof.

20. A liquid laundry detergent composition comprising methyl ester sulfonate, produced by the process according to claim 1.

21. A method of preventing or reducing disalt formation in a liquid laundry detergent composition comprising methyl ester sulfonate, said method comprising maintaining the pH of the manufacturing process between about 5 and about 9 and maintaining the temperature of the manufacturing process between about 20° C. to about 100° C.
